(19) United States
(12) Patent Application Publication
(10) Pub. No.: US 2024/0327256 A1
(43) Pub. Date: Oct. 3, 2024

(54) ELECTRO-COAGULATION APPARATUS

(71) Applicant: SK INNOVATION CO., LTD., Seoul (KR)

(72) Inventors: Yeon Hwa LA, Daejeon (KR); Tae Wan KIM, Daejeon (KR); Jae Yang SONG, Daejeon (KR)

(21) Appl. No.: 18/625,209

(22) Filed: Apr. 3, 2024

(30) Foreign Application Priority Data
Apr. 3, 2023 (KR) 10-2023-0043625

(51) Int. Cl. C02F 1/463; C02F 1/461

(52) U.S. Cl. CPC C02F 1/463; C02F 1/46109; C02F 2001/46152; C02F 2201/4616

(57) ABSTRACT

Proposed is an electro-coagulation apparatus. The electro-coagulation apparatus includes a reactor having an internal space defined by a top surface, a bottom surface, and a side surface of the reactor; a plurality of electrode plates disposed spaced apart from each other inside the internal space of the reactor, and a pair of first conduits respectively connected to a front end and a rear end of the reactor. Furthermore, a cross-sectional area of the reactor is smaller than a cross-sectional area of each of the first conduits.

### CROSS REFERENCE TO RELATED APPLICATION

This patent application claims the priority and benefits of Korean Patent Application No. 10-2023-0043625, filed Apr. 3, 2023, the entire contents of which are incorporated herein by reference for all purposes.

### TECHNICAL FIELD

Embodiments of the present disclosure relate to an electro-coagulation apparatus.

### BACKGROUND

Wastewater refers to water that cannot be used as it is, since liquid type water contaminants or solid type water contaminants are mixed in the water. In a broad sense, wastewater includes domestic sewage, laundry wastewater, industrial wastewater, agricultural and livestock wastewater, and so on.

Wastewater treatment is a process that removes harmful effects on rivers and oceans into which wastewater flows by removing contaminants or harmful substances contained in wastewater. Wastewater treatment methods include a physical treatment method such as a screening method, a filtration method, a sedimentation method, a distillation method, an evaporation method, a magnetic separation method, and so on, and include a chemical treatment method such as a neutralization method, an oxidation reduction method, a decomposition method, a coagulation method, an adsorption method, a flotation method, an extraction method, an ion exchange method, a stripping method, a combustion/incineration method, and so on. Furthermore, wastewater treatment methods include an aerobic biological treatment method such as an active sludge method, a trickling filter method, an oxidation tank method, a rotating disc method, a contact oxidation method, and so on, and include an anaerobic biological treatment method such as a digestion method (a methane fermentation method), a septic tank method, and so on.

An electro-coagulation technology is a technology that supplies electricity into wastewater and destabilizes suspended particles, emulsified particles, insoluble particles, and so on of contaminants. When electrodes are positioned in wastewater and electricity is supplied, a soluble electrode of an anode is oxidized by an electrochemical reaction, and metal cations are generated. The metal cations are convected and diffused by an electric field and a concentration gradient, and are electrically coupled to contaminants and are neutralized, thereby forming flocs.

A conventional electro-coagulation apparatus may be classified into a vertical type electro-coagulation apparatus and a horizontal type electro-coagulation apparatus. In the vertical type electro-coagulation apparatus, wastewater flows from a lower portion of the apparatus to an upper portion of the apparatus. Due to the presence of hydrogen and oxygen gases that occur during the electro-coagulation reaction, flocs generated inside the apparatus are raised and overflow, and the flocs are then removed from wastewater through precipitation, and so on. The vertical type electro-coagulation apparatus may be classified as an open type electro-coagulation apparatus since an upper end of the apparatus is opened for overflow.

The horizontal type electro-coagulation apparatus may be classified as a closed type electro-coagulation apparatus, and wastewater moves in a horizontal direction. In the conventional horizontal type electro-coagulation apparatus, wastewater is moved to a reactor having a relatively large cross-sectional area through a conduit having a relatively small cross-sectional area, and the electro-coagulation reaction is performed in the reactor.

### SUMMARY

Embodiments of the present disclosure provide an improved electro-coagulation apparatus.

In an embodiment of the present disclosure, there is provided an electro-coagulation apparatus including a reactor having an internal space defined by an top surface, a bottom surface, and a side surface of the reactor; a plurality of electrode plates disposed spaced apart from each other inside the internal space of the reactor, and a pair of first conduits respectively connected to a front end and a rear end of the reactor, wherein a cross-sectional area of the reactor is smaller than a cross-sectional area of each of the first conduits.

In an embodiment, each main surface of the plurality of electrode plates faces the side surface of the reactor.

In an embodiment, the reactor may include a first and second electrode support parts configured to restrict the plurality of electrode plates from being moved in a width direction and a longitudinal direction.

In an embodiment, the first electrode support part may be fixed to the bottom surface of the reactor, and may extend along a longitudinal direction of the reactor.

In an embodiment, the second electrode support part may be fixed to at least one of the top surface (or upper surface) and the bottom surface (or lower surface) of the reactor, and may extend along a width direction of the reactor at the rear end of the reactor.

In an embodiment, each cross-sectional area of the first conduits may be at least 1.5 times the cross-sectional area of the reactor.

In an embodiment, the electro-coagulation apparatus may further include a plurality of power source contacts configured to apply a voltage to the plurality of electrode plates.

In an embodiment, the top surface of the reactor may be capable of being opened and closed.

In an embodiment, the electro-coagulation apparatus may further include a pair of second conduits respectively connected to a front end and a rear end of the pair of first conduits.

In an embodiment, each cross-sectional area of the second conduits may be smaller than each cross-sectional area of the first conduits.

In an embodiment of the present disclosure, there is provided an electro-coagulation apparatus including a reactor comprising a plurality of electrode plates spaced apart from each other inside an internal space of the reactor, a pair of power source contacts configured to apply a voltage to the plurality of electrode plates; and a plurality of first and second electrode supports for securing the plurality of the electrode plates inside the reactor and preventing the plurality of electrode plates from being moved in a width direction and a longitudinal direction. Embodiments of the present disclosure provide an electro-coagulation apparatus capable of having a relatively reduced size. The electro-coagulation apparatus of the present disclosure may provide further improved removal efficiency of contaminants in wastewater.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view schematically illustrating an electro-coagulation apparatus according to an embodiment of the present disclosure; and

FIG. 2 is a view schematically illustrating a reactor according to an embodiment of the present disclosure.

### DETAILED DESCRIPTION

Objectives, advantages, and features of the present disclosure will be more apparent from the following detailed description and embodiments taken in connection with the accompanying drawings, but the present disclosure is not limited thereto. Furthermore, in the description of the present disclosure, it is to be noted that, when known techniques related to the embodiments of the present disclosure make the gist of the present disclosure unclear, a detailed description thereof will be omitted.

Embodiments of the present disclosure relate to an electro-coagulation apparatus. In the removal of contaminants in wastewater, the application of an electro-coagulation method has advantages that a structure of an apparatus is simple and an operation of the apparatus is conveniently performed. In addition, since a sludge generated through electro-coagulation is mainly composed of metal hydroxide, the sludge is easily precipitated, dehydration of the sludge is conveniently performed, and a generation amount of the sludge is low. In addition, a floc formed by the electro-coagulation has a size larger than a size of a floc formed by chemical coagulation, has a lower content of water, and has a tendency to be strong and stable in acid. In addition, since a TDS (Total Dissolved Solid) content of treated water after the electro-coagulation is lower than a TDS content of treated water after the chemical coagulation, the treatment cost for reuse is low. In addition, unlike the chemical coagulation that requires a coagulant, since a chemical agent is not used in the electro-coagulation, there is no need to neutralize the chemical agent, so that a secondary treatment is not required to be performed. In the present disclosure, the ‘contaminants’ may include organic substances, microplastics, and so on, but are not particularly limited as long as the contaminants are substances present in wastewater and required to be removed during a wastewater purification process.

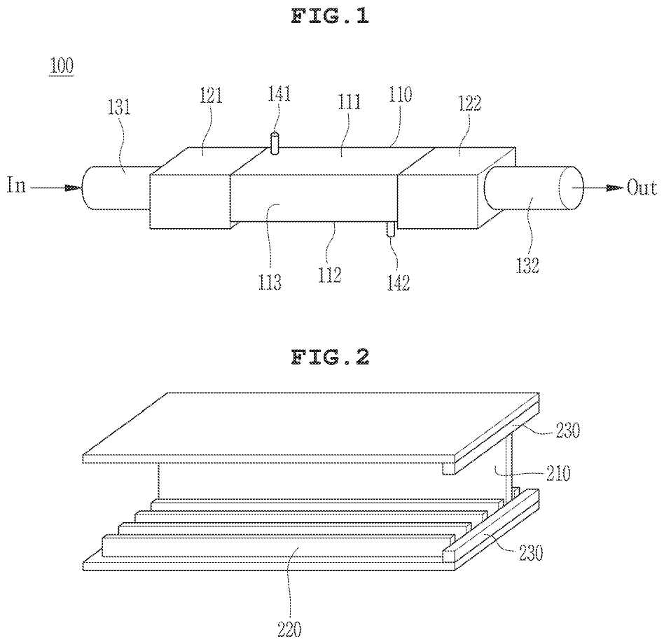

Hereinafter, an electro-coagulation apparatus of the present disclosure will be described in more detail with reference to the accompanying drawings. FIG. 1 is a view schematically illustrating an electro-coagulation apparatus according to an embodiment of the present disclosure. However, it should be noted that FIG. 1 is an example, and configurations of the electro-coagulation apparatus of the present disclosure are not limited to configurations of the electro-coagulation apparatus illustrated in FIG. 1. Referring to FIG. 1, an electro-coagulation apparatus 100 includes a reactor 110 and a pair of first conduits 121 and 122 that are respectively connected to a front end and a rear end of the reactor 110. Fluid introduced into the electro-coagulation apparatus is introduced into the reactor 110 through the first conduit 121, and then is discharged out of the reactor 110 through the first conduit 122.

The reactor 110 has an internal space defined by a top surface 111, a bottom surface 112, and a side surface 113. FIG. 2 is a view schematically illustrating a reactor 110 according to an embodiment. Referring to FIG. 2, the reactor 110 includes a plurality of electrode plates 210. The electrode plates may be spaced apart from each other in the internal space. According to an embodiment of the present disclosure, the reactor may have a cuboid shape or a rectangular prism shape. A structure of the reactor 110 having the cuboid or rectangular prism shape may be configured such that the top surface 111 of the reactor 110 is capable of being opened and closed, so that design of the structure of the reactor is capable of being conveniently performed. As a result, the structure of the reactor is preferable since the electrode plates are capable of being conveniently replaced after the apparatus is operated.

The electrodes disposed in the apparatus may have a plate shape. The electrodes having the plate shape may be conveniently disposed inside the reactor by being spaced apart from each other by a predetermined distance, and are therefore advantageous in that they may facilitate replacement of any used electrodes. The ‘plurality of electrode plates’ refers to at least two electrode plates. For example, the reactor 110 may include 2 to 15 electrode plates, or 2 to 12 electrode plates. However, the number of electrode plates 210 in the reactor may vary according to the size of the reactor, the thickness of the electrode plates, and the application in which the electro-coagulation apparatus may be used.

In an embodiment of the present disclosure, the plurality of electrode plates 210 may be disposed such that each main surface of the plurality of electrode plates faces the side surface of the reactor 110. Accordingly, the fluid introduced into the reactor 110 may flow across the main surface of each electrode plate 210 and may be in contact with the main surface of each electrode plate 210, and then may be discharged out of the reactor 210. The positioning of the main surface of each electrode plate 210 so that the main surface of each electrode plate faces the side surface of the reactor is more advantageous in that the positioning is easier to maintain the predetermined distance between the electrode plates 210 compared to positioning the main surface of each electrode plate so that the main surface of each electrode plate faces the top surface 111 and/or the bottom surface 112 of the reactor 110, and is more advantageous in that replacing the electrode plates 210 by opening the top surface 111 is capable of being conveniently performed.

The length, the height, and the thickness of each electrode plate 210 may vary according to the size of the internal space of the reactor. Specifically, the length of the electrode plate may vary according to a longitudinal direction of the reactor, the height of the electrode plate may vary according to a height direction of the reactor, and the thickness of the electrode plate may vary according to a width direction of the reactor. In the present disclosure, the ‘longitudinal direction’ of the reactor refers to a direction from the front end of the reactor connected to the first conduit 121 to the rear end of the reactor connected to the first conduit 122. In addition, the ‘height direction’ of the reactor refers to a direction from the bottom surface of the reactor to the top surface of the reactor, or refers to an opposite direction. In addition, the ‘width direction’ of the reactor refers to a direction from a one side surface of the reactor to an opposite side surface of the reactor. In the present disclosure, with respect to the electrode plate and a first electrode support part, the ‘width’ may be used interchangeably with the ‘thickness’.

In the present disclosure, the length of the electrode plate may be at least about 80% of the length of the reactor, preferably at least about 90%, more preferably at least about 95%, and further preferably at least about 95% to 97% of the length of the reactor. The length of the electrode plate is as close as possible to the length of the reactor, but the length of the electrode plate may be designed in consideration of the presence of an electrode support that will be described later.

In addition, the height of the electrode plate may be at least about 80% of the height of the reactor, preferably at least about 90%, and more preferably at least about 90% to 95% of the height of the reactor.

The thickness of the electrode plate is not particularly limited as long as the electrode plate is capable of being mounted inside the reactor. Preferably, the thickness of the electrode plate may be about 1 mm to 5 mm, such as about 1 mm to 2 mm, about 1 mm to 3 mm, about 1 mm to 4 mm, about 2 mm to 3 mm, about 2 mm to 4 mm, about 2 mm to 5 mm, about 3 mm to 4 mm, about 3 mm to 5 mm, and about 4 mm to 5 mm. When the thickness of the electrode plate is too thin, a replacement period of the electrode is shortened, and a problem that the electrode plate is bent during operating the apparatus may occur. Conversely, when the thickness of the electrode plate is too thick, a problem in which a resistance value of the electrode plate is excessively increased may occur.

The plurality of electrode plates of the present disclosure may be connected in a monopolar manner or a bipolar manner. In an embodiment of the present disclosure, the apparatus may further include power source contacts 141 and 142 configured to apply a voltage to the plurality of electrode plates. The power source contacts are connected to at least a portion of the plurality of electrode plates, and are configured to apply a voltage to the plurality of electrode plates. When the plurality of electrode plates is connected in the monopolar manner, a voltage may be applied to each of the plurality of electrode plates. For example, the plurality of electrode plates may be alternately functioning as an anode and a cathode and may be connected to the power source contacts. When the plurality of electrode plates is connected in the bipolar manner, each of two electrodes disposed closest to both side surfaces of the reactor may be respectively functioning as an anode and a cathode and may be connected to the power source contacts. When three or more electrode plates are used, in terms of convenience of maintenance, the bipolar method in which wires are connected only to two electrodes that are disposed closest to both side surfaces of the reactor may be preferable to the monopolar method in which wires are required to be connected to all of the electrode plates.

When a voltage is applied to the electrode plates, metal cations are discharged from the anode as metal is dissolved, thereby generating metal hydroxide. Furthermore, metal hydroxide coagulates with contaminants in wastewater and form flocs. Therefore, as time passes, the size of the anode gradually decreases. In addition, water in contact with the anode is decomposed and hydrogen gas is generated. On the other hand, when a voltage is applied to the cathode, water in contact with the cathode is decomposed and oxygen gas is generated.

The plurality of electrode plates of the present disclosure may be metal electrodes. The plurality of electrode plates of the present disclosure may be consumable electrodes. The electrodes may be oxidized and discharge metal cations into wastewater when a voltage is applied thereto. The type of the electrodes is not specifically limited as long as the electrodes may be used as the consumable electrode. According to an embodiment of the present disclosure, the electrodes may include, for example, iron or aluminum or combinations thereof. In an embodiment, the electrodes may consist of iron, aluminum, or a combination thereof. In terms of electro-coagulation efficiency, apparatus maintenance, and repair, it may be advantageous that the plurality of electrode plates may be all formed of the same material.

The plurality of electrode plates 210 of the present disclosure may be disposed inside the reactor 110 such that the plurality of electrode plates 210 may be spaced apart from each other by a predetermined distance. For example, the plurality of electrode plates 210 may be spaced apart from each other by a distance of about 5 mm to 15 mm. Here, the distance refers to the shortest distance between a second main surface of a first electrode plate and a first main surface of a second electrode plate adjacent to the first electrode plate. Here, the second main surface of the first electrode plate faces the first main surface of another electrode plate adjacent to the first electrode plate.

For example, in an embodiment of the present disclosure, the reactor may include first electrode support parts 220. Each first electrode support part 220 may be positioned on both sides of each electrode plate 210, thereby restricting each of the plurality of electrode plates 210 from moving in the width direction of the reactor 110. The number of first electrode support parts 220 inside the reactor 110 may be determined according to the maximum number of the electrode plates 210 that can be disposed in the reactor 110. Specifically, the number of the first electrode support parts 220 in the reactor 110 may be a number acquired by subtracting one from the maximum number of the electrode plates that can be disposed in the reactor 110. For example, when the maximum number of the electrode plates disposed in the reactor is ten, the number of the first electrode support parts in the reactor may be nine.

As illustrated in FIG. 2, each of the first electrode support parts 220 may be fixed to the bottom surface of the reactor, and may extend along the longitudinal direction of the reactor 110. The length of the first electrode support part may be equal to or smaller than the length of the electrode plate. The thickness and the height of the first electrode support part are selected to adequately (or sufficiently) restrict the movement of the electrode plate in the width direction so that the plurality of electrode plates may not contact each other. In addition, preferably, the first electrode support part may have a thickness and a height sufficient to allow electric conduction between the electrode plates adjacent to each other and which are sufficient to allow wastewater to flow along the longitudinal direction of the reactor. For example, the thickness of the first electrode support part may be about 0.5 times to 2 times the thickness of the electrode plate, but the embodiments are not limited thereto. In addition, the height of the first electrode support part may be about 0.05 times to 0.5 times the height of the electrode plate, such as about 0.1 times to 0.3 times the height of the electrode plate, but the embodiments are not limited thereto.

The first electrode support part 220 may be formed of a material having an insulating characteristic and/or chemical resistance. For example, the material constituting the first electrode support part may be rubber, silicone, acrylic, PVC, FRP, and so on, but the embodiments are not limited thereto.

In an embodiment of the present disclosure, the reactor 110 may include a second electrode support part 230. The second electrode support part prevents the plurality of electrode plates disposed inside the reactor from being moved toward the first conduit 122 due to the inflow of wastewater into the reactor. That is, the second electrode support part restricts the plurality of electrode plates from being moved in the longitudinal direction.

The second electrode support part 230 may be positioned on the rear end of the longitudinal direction of the reactor 110. In an embodiment, the second electrode support part 230 may be positioned on the rearmost end of the longitudinal direction of the reactor 110. In addition, as illustrated in FIG. 2, the second electrode support part 230 may extend along the width direction of the reactor 110, and may be in contact with both side surfaces 113 of the reactor 110. The second electrode support part 230 may be fixed to one of the top surface and the bottom surface of the reactor. The reactor 110 may include a plurality of second electrode support parts 230. For example, when the reactor 110 includes two second electrode support parts 230, one second electrode support part may be fixed to the bottom surface of the rearmost end of the reactor, and may extend in an width direction of the reactor and may be in contact with both side surfaces of the reactor. In addition, the other second electrode support part may be fixed to the top surface of the rearmost end of the reactor, and may extend in the width direction of the reactor and may be in contact with both side surfaces of the reactor.

When the second electrode support part is fixed to the bottom surface of the reactor, it may be advantageous that the second electrode support part is also fixed to both side surfaces of the reactor so as to withstand the resistance caused by the flow of wastewater in the reactor.

The length of the second electrode support part may be at least about 90%, at least about 92%, at least about 95%, at least about 97%, or at least about 99% of the width of the internal space of the reactor. Considering that it is possible to control the longitudinal movement of the plurality of electrode plates through one second electrode support part, it may be advantageous that the length of the second electrode support part is equal to the width of the internal space of the reactor. It may be advantageous that the height and the width of the second electrode support part be small enough to control the movement of the plurality of electrode plates. For example, the height of the second electrode support part may be about 0.05 times to 0.5 times the height of the electrode plate, such as about 0.1 times to 0.3 times the height of the electrode plate, but the embodiments are not limited thereto.

Similar to the first electrode support part 220, the second electrode support part 230 may also be formed of a material having an insulating characteristic and/or chemical resistance. For example, the material constituting the second electrode support part 230 may be rubber, silicone, acrylic, PVC, FRP, and so on, but the embodiments are not limited thereto. In an embodiment of the present disclosure, the first electrode support part 220 and the second electrode support part 230 may be formed of the same material.

In an embodiment of the present disclosure, the top surface 111 of the reactor 110 may be capable of being opened and closed. Alternatively, the top surface 111 of the reactor 110 may have a detachable structure. This may be advantageous for it may facilitate the maintenance of the plurality of electrode plates 210 which may be consumed during the electro-coagulation reaction.

In the electro-coagulation apparatus of the present disclosure, the cross-sectional area of the reactor is smaller than the cross-sectional areas of the first conduits. Each cross-sectional area of the pair of first conduits 121 and 122 is larger than the cross-sectional area of the reactor. In addition, in some examples, the pair of first conduits may have the same cross-sectional area and the same cross-sectional shape. The reactor and the pair of first conduits at the front and rear ends of the reactor have shapes the same as one venturi tube. Since the reactor and the first conduits have such a shape, wastewater in the reactor flows at a higher flow rate than wastewater in the first conduits. This situation may prevent contaminants in wastewater from being deposited on the surface of the electrode plates, so that fouling in the reactor may be prevented as a result.

In addition, in the structure of the apparatus of the present disclosure as described above, hydrogen and oxygen gases generated in the reactor during the electro-coagulation reaction may exist in the form of microbubbles. In a conventional electro-coagulation apparatus, especially in a conventional horizontal type electro-coagulation apparatus in which a cross-sectional area of a first conduit is smaller than a cross-sectional area of the reactor, hydrogen and oxygen gases generated in the reactor during the reaction are present as relatively large bubbles. The presence of the relatively large bubbles in the reactor makes electrical conduction between electrodes in the reactor difficult. Therefore, the conventional electro-coagulation apparatus has a problem in that the electro-coagulation efficiency is reduced due to the generation of large bubbles. In contrast, in the embodiments of the present disclosure, hydrogen and oxygen gases may exist in the reactor of the electro-coagulation apparatus in the form of microbubbles as described above, so that a decrease in the electro-coagulation efficiency due to the generation of large bubbles may be prevented.

In an embodiment of the present disclosure, each cross-sectional area of the first conduits 121, 122 may be at least about 1.5 times the cross-sectional area of the reactor 110. For example, each cross-sectional area of the first conduits 121, 122 may be about 1.5 times to 5.0 times the cross-sectional area of the reactor 110, or may be about 1.5 times to 3.0 times the cross-sectional area of the reactor 110. When the cross-sectional area difference is less than about 1.5 times, the flow rate difference between wastewater in the first conduits and wastewater in the reactor is not large, so that there is a problem that it may be difficult to restrict the generation of large bubbles. Conversely, when the cross-sectional area difference exceeds about 5.0 times, the flow rate of wastewater in the reactor may increase excessively, so that an electro-coagulation effect may be reduced.

For example, when each cross-sectional area of the first conduits is at least about 1.5 times the cross-sectional area of the reactor, the flow rate of fluid in the reactor may be at least about 1.5 times the flow rate of fluid in the first conduits. Particularly, when all of the plurality of electrode plates are mounted inside the reactor, the flow rate of fluid in the reactor may be at least three times the flow rate of fluid in the first conduits.

In an embodiment of the present disclosure, the electro-coagulation apparatus may further include a pair of second conduits 131 and 132. As illustrated in FIG. 1, the second conduit 131 may be connected to the front end of the first conduit 121, and the second conduit 132 may be connected to the rear end of the first conduit 122. Accordingly, wastewater is introduced into the reactor by sequentially passing through the second conduit 131 and the first conduit 121, and is discharged from the reactor by sequentially passing through the first conduit 122 and the second conduit 132.

Each cross-sectional area of the second conduits 131, 132 is smaller than each cross-sectional area of the first conduits 121, 122. This structure causes a decrease in the flow rate of wastewater that is introduced into the first conduit through the second conduit, so that it is expected that the venturi effect of the reactor is further increased. In addition, the second conduit 131 facilitates the flow of wastewater into the first conduit 121. Furthermore, since the second conduit 132 has the cross-sectional area smaller than the cross-sectional area of the first conduit 122, the flow rate of fluid in the second conduit 132 is increased, so that flocs formed in the reactor are not immersed in the first conduit 122 and are smoothly discharged to the outside.

Each cross-sectional area of the pair of second conduits 131 and 132 is smaller than each cross-sectional area of the pair of first conduits 121 and 122 that are respectively connected to the pair of second conduits 131 and 132. In some examples, the pair of second conduits may have the same cross-sectional area and the same cross-sectional shape.

In some embodiments, each cross-sectional area of the second conduits 131, 132 may be larger than the cross-sectional area of the reactor 110. Furthermore, in some other embodiments, each cross-sectional area of the second conduits 131, 132 may be smaller than the cross-sectional area of the reactor 110. Furthermore, in still other embodiments, each cross-sectional area of the second conduits 131, 132 may be the same as the cross-sectional area of the reactor 110.

In addition, in an embodiment of the present disclosure, each of the second conduits 131, 132 may have the cross-sectional area the same as the cross-sectional area of an external conduit. Here, the term ‘external conduit’ is a conduit connected to the electro-coagulation apparatus of the present disclosure, configured to supply wastewater, and configured to transmit wastewater discharged from the apparatus to other apparatuses, facilities, and so on, and there is no specific limitation in the external conduit.

The electro-coagulation apparatus of the present disclosure as described above may be substantially compacted or miniaturized compared to a conventional apparatus, and it is expected that the electro-coagulation apparatus of the present disclosure is capable of providing performance of removing contaminants in wastewater with a higher efficiency.

Simple changes and modifications to the embodiments of the present disclosure are appreciated as included in the scope and technical concept of the present disclosure, and the protection scope of the embodiments of the present disclosure will be defined by the claims. Furthermore, the embodiments may be combined to form additional embodiments.

What is claimed is:

1. An electro-coagulation apparatus comprising:
a reactor having an internal space defined by a top surface, a bottom surface, and a side surface of the reactor,
a plurality of electrode plates disposed spaced apart from each other inside the internal space of the reactor, and
a pair of first conduits respectively connected to a front end and a rear end of the reactor,
wherein a cross-sectional area of the reactor is smaller than a cross-sectional area of each of the first conduits.

2. The electro-coagulation apparatus of claim 1, wherein each main surface of the plurality of electrode plates faces the side surface of the reactor.

3. The electro-coagulation apparatus of claim 1, wherein the reactor comprises:
first and second electrode support parts configured to restrict the plurality of electrode plates from being moved in a width direction and a longitudinal direction.

4. The electro-coagulation apparatus of claim 3, wherein the first electrode support part is fixed to the bottom surface of the reactor, and extends along a longitudinal direction of the reactor.

5. The electro-coagulation apparatus of claim 3, wherein the second electrode support part is fixed to at least one of the top surface and the bottom surface of the reactor, and extends along a width direction of the reactor at the rear end of the reactor.

6. The electro-coagulation apparatus of claim 1, wherein each cross-sectional area of the first conduits is at least 1.5 times the cross-sectional area of the reactor.

7. The electro-coagulation apparatus of claim 1, further comprising a plurality of power source contacts configured to apply a voltage to the plurality of electrode plates.

8. The electro-coagulation apparatus of claim 1, wherein the top surface of the reactor is capable of being opened and closed.

9. The electro-coagulation apparatus of claim 1, further comprising a pair of second conduits respectively connected to a front end and a rear end of the pair of first conduits.

10. The electro-coagulation apparatus of claim 9, wherein each cross-sectional area of the second conduits is smaller than each cross-sectional area of the first conduits.

11. An electro-coagulation apparatus comprising:
a reactor comprising a plurality of electrode plates spaced apart from each other inside an internal space of the reactor;
a pair of power source contacts configured to apply a voltage to the plurality of electrode plates; and
a plurality of first and second electrode supports for securing the plurality of the electrode plates inside the reactor and preventing the plurality of electrode plates from being moved in a width direction and a longitudinal direction.
